(19) United States
(12) Patent Application Publication
(10) Pub. No.: US 2012/0109911 A1
(43) Pub. Date: May 3, 2012

(54) Compression Of XML Data

(76) Inventors: D. Blair Elzinga, Albany, OR (US); Santhakumar Krishnamoorthy, San Jose, CA (US)

(21) Appl. No.: 13/382,247

(22) PCT Filed: Jul. 31, 2009
(86) PCT No.: PCT/US09/52350

§ 371 Date: Jan. 4, 2012

(51) Int. Cl. G06F 17/30

(52) U.S. Cl. 707/693; 707/E17.002

(57) ABSTRACT

Methods of compressing XML source data include identifying each element type of the XML source data, generating a representation of element names for each identified element type, and generating a representation of data content for each instance of each element type separate from the representation of element names of the element types.

### BACKGROUND

Data compression involves encoding raw data to a representation using fewer bits that the original raw data. Such compression is useful because less resources are required to store and/or transmit the compressed data. However, compression is only useful if both the creator of the compressed data and the user of the compressed data have access to the encoding scheme.

XML (eXtensible Markup Language) is an open standard for structuring data. XML separates data structure from data content and thus provides a good standards-based platform for data archival. However, XML typically expands the size of the original structured data by 10-20 times unless the XML data is compressed. In addition, standard data compression techniques tend to reduce the XML data to only about the original size of the uncompressed data content. Lempel-Ziv (LZ) compression is one example of a data compression technique.

Manipulating, accessing or otherwise parsing compressed XML files generally requires that the file first be decompressed. This typically results in the need to either read the entire XML file into memory, or to read the data sequentially from the file. Example parsing techniques include DOM XML parsing, SAX XML parsing and VTD XML parsing.

For the reasons stated above, and for other reasons that will become apparent to those skilled in the art upon reading and understanding the present specification, there is a need in the art for alternative methods and apparatus for compressing XML data.

### BRIEF DESCRIPTION OF THE DRAWINGS

FIG. 1 shows an exemplary computer system 100 suitable for compressing XML source data in accordance with embodiments of the disclosure.

FIGS. 2A-2C collectively represent an example of XML source data to be used in describing various features of embodiments of the disclosure.

FIGS. 3A-3C collectively represent examples of compressed data structures generated in response to the XML source data of FIGS. 2A-2C in accordance with embodiments of the disclosure.

FIG. 4 is a representation of a sample compression dictionary for use in generating the compressed data structure of FIG. 3C in accordance with embodiments of the disclosure.

FIG. 5 depicts a representation of the hierarchy of the data structure of the XML source data of FIGS. 2A-2C as a tree index in accordance with an embodiment of the disclosure.

FIGS. 6A-6B represent compressed file structures in accordance with embodiments of the disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process, electrical or mechanical changes may be made without departing from the scope of the present disclosure. The following detailed description is, therefore, not to be taken in a limiting sense, and the scope of the present disclosure is defined by the appended claims and equivalents thereof.

XML (eXtensible Markup Language) is a data structure to store and transport data. XML includes a root element, from which all other elements depend. Each element includes an opening tag, e.g., <Root_Element>, and a closing tag, e.g., <Root_Element>. Each element can include other elements (i.e., child elements) or textual content (i.e., data content) between its opening and closing tags. Any element containing a child element will be considered a parent element to that child element. Child elements will fall into two classes, i.e., those containing other elements and those containing only data content.

Various embodiments provide a method for archiving high compression ratios with XML data and at the same time enabling high-speed, random access to the compressed XML data without requiring the entire file to be read or decompressed. Various embodiments facilitate compression and access by reorganizing the data structure to separate element names and data content. The hierarchy of the XML data is first identified. Groups of data hierarchies that share the same structure are physically blocked together as a parent element and any of its child elements containing only data content. A hierarchy group is defined for each element type associated with an element name that represents a parent element. That is, each element that is a parent element to one or more child elements will represent an element type, and will be grouped with like hierarchies. Note that an element type of a particular hierarchy group may further contain one or more child elements containing other elements, which would result in another hierarchy group of a different element type for each such child element that further serves as a parent element to other elements.

By grouping the data hierarchies, the often-lengthy element names can be separated from the data content and are stored only once for that hierarchy instead of being repeated, thereby transforming the data structure. A counter is created for each instance within the hierarchy as it is logically moved to the block of like hierarchies. This allows the decompression to duplicate the relative order between hierarchies. This process generates a file, e.g., a plain-text file, representing a compressed version of the XML source data file.

For some embodiments, a jump list is created to facilitate random access of the compressed file. A jump list may contains values indicative of a location of a list of element names associated with a particular element type and of a length of the element names, as well as a location of the data content corresponding to the element names associated with the particular element type for one or more instances of that element type. For example, a jump list may contain a value indicative of a location in the compressed file of the list of element names associated with a particular element type and a value indicative of the length of that list of element names; a value indicative of a location in the compressed file of a list of data values representative of the data content of a first instance of the particular element type and their length; a value indicative of a location in the compressed file of a list of data values representative of the data content of a second instance of the particular element type and their length; etc. The jump list may be separate from the compressed file, or it may be added to the compressed file.

For further embodiments, additional compression algorithms are applied to facilitate further reduction in the size of the transformed data structure. For example, as the XML reorganization is performed as a first-tier compression, a second-tier compression technique, e.g., L-Z (Lempel-Ziv) compression, may be applied. To facilitate random access without decompressing this dual-compressed file, compression techniques utilizing a discrete dictionary may be used. By storing the dictionary separate from the dual-compressed file, or by attaching the dictionary in a specified location within the dual-compressed file, only the relevant portion of the dual-compressed file need be decompressed to access a specific data value or set of data values. It is noted that the jump list, if utilized, should be created to indicate the relevant locations and lengths within the compressed file, whether only reorganized or reorganized and compressed.

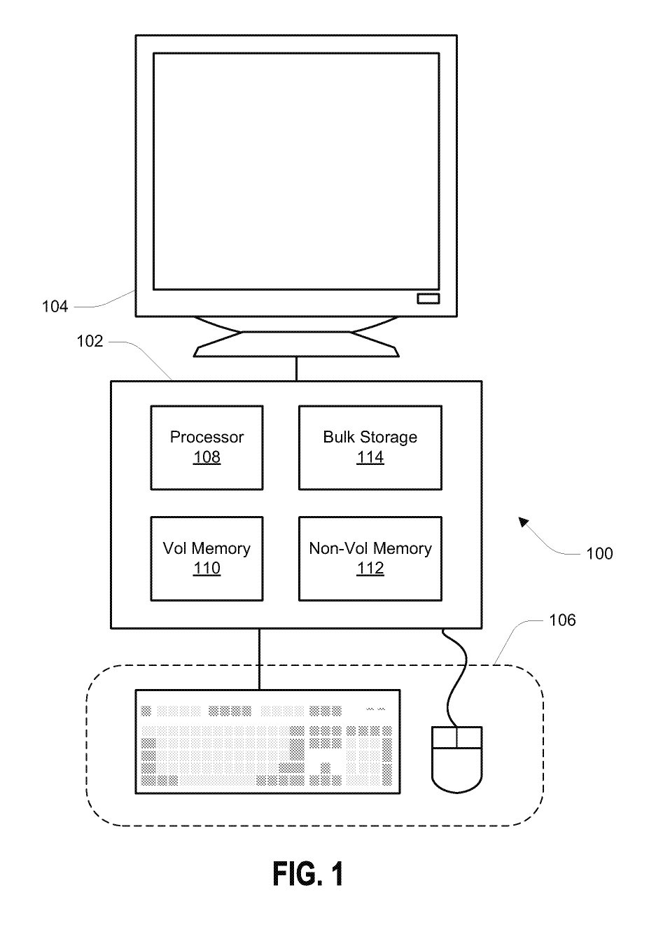

Various embodiments will now be described with reference to a particular example. FIG. 1 shows an exemplary computer system 100 suitable for compressing XML source data in accordance with embodiments of the disclosure. The computer system 100 includes a computing device 102, one or more output devices 104 and one or more user input devices 106.

The computing device 102 may represent a variety of computing devices, such as a network server, a personal computer or the like. The computing device 102 may further take a variety of forms, such as a desktop device, a blade device, a portable device or the like. Although depicted as a display, the output devices 104 may represent a variety of devices for providing audio and/or visual feedback to a user, such as a graphics display, a text display, a touch screen, a speaker or headset, a printer or the like. Although depicted as a keyboard and mouse, the user input devices 106 may represent a variety of devices for providing input to the computing device 102 from a user, such as a keyboard, a pointing device, selectable controls on a user control panel, or the like.

Computing device 102 typically includes one or more processors 108 that process various instructions to control the operation of computing device 102 and communicate with other electronic and computing devices. Computing device 102 may be implemented with one or more memory components, examples of which include a volatile memory 110, such as random access memory (RAM); non-volatile memory 112, such as read-only memory (ROM), flash memory or the like; and/ora bulk storage device 114. Common examples of bulk storage devices include any type of magnetic, optical or solid-state storage device, such as a hard disc drive, a solid-state drive, a magnetic tape, a recordable/ rewriteable optical disc, and the like. The one or more memory components may be fixed to the computing device 102 or removable.

The one or more memory components are computer-usable storage media to provide data storage mechanisms to store various information and/or data for and during operation of the computing device 102, and to store machine-readable instructions adapted to cause the processor 108 to perform some functions. An operating system and one or more application programs may be stored in the one or more memory components for execution by the processor 108. Storage of the operating system and most application programs is typically on the bulk storage device 114, although portions of the operating system and/or applications may be copied from the bulk storage device 114 to other memory components during operation of the computing device 102 for faster access. One or more of the memory components contain machine-readable instructions adapted to cause the processor 108 to perform methods in accordance with embodiments of the disclosure. For some embodiments, one or more of the memory components contain the XML data file to be compressed and/or the compressed XML data file.

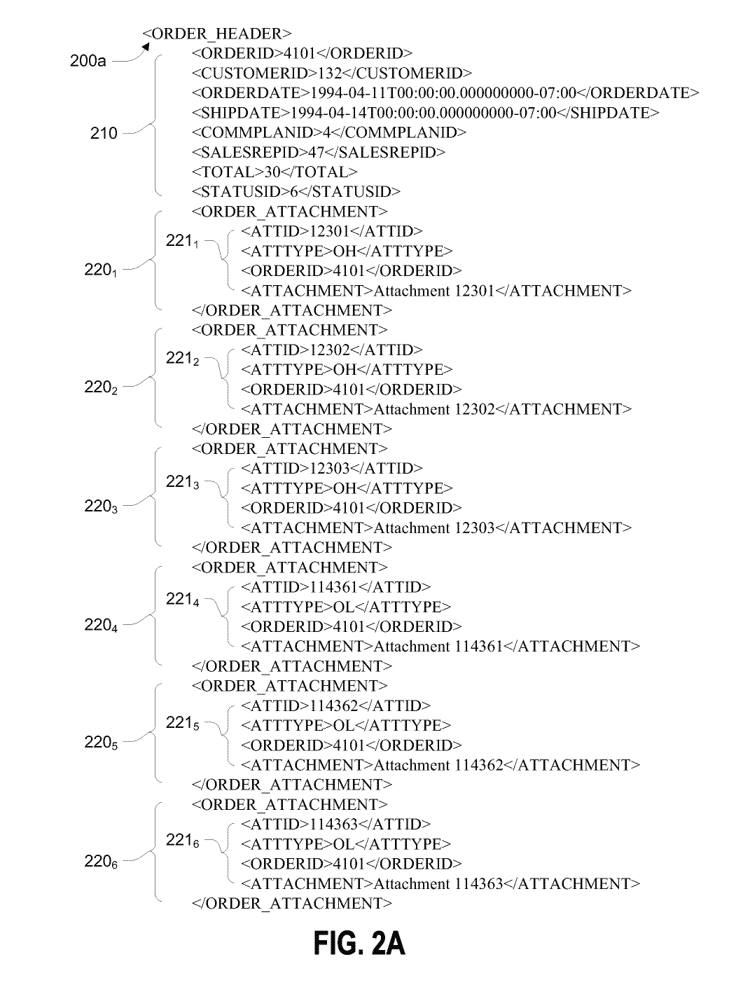

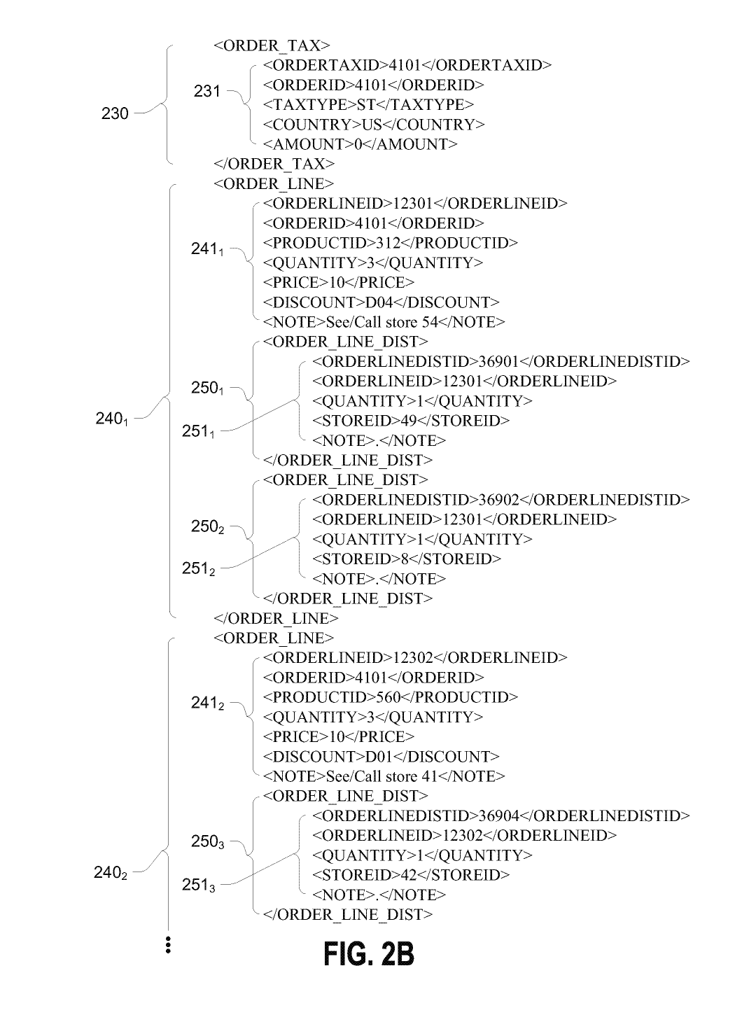

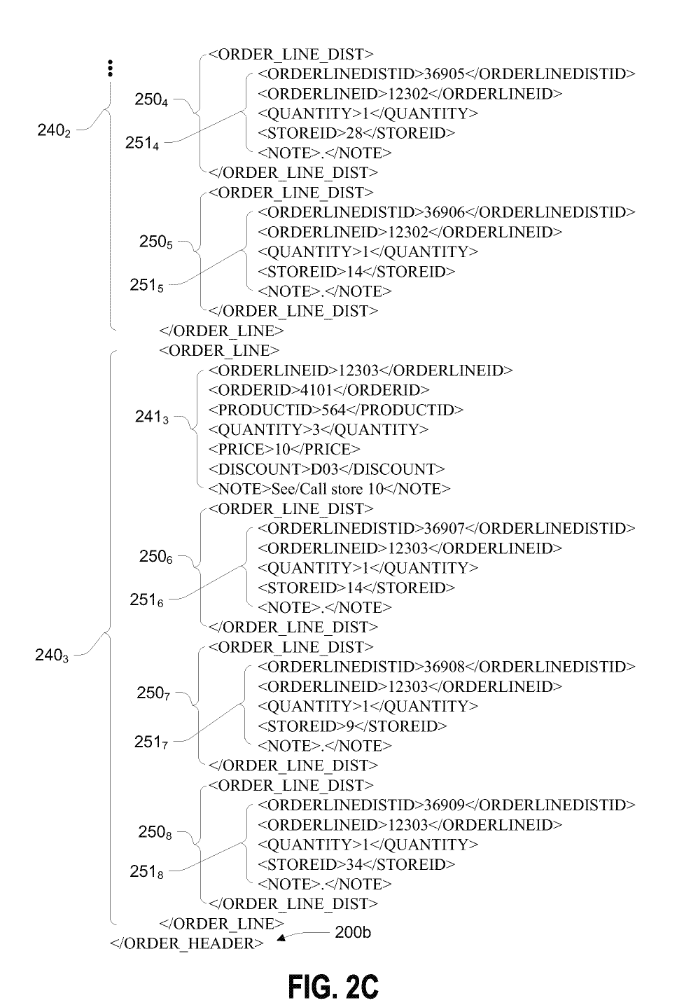

FIGS. 2A-2C collectively represent an example of XML source data to be used in describing various features of embodiments of the disclosure. The XML source data file includes a root element, ORDER_HEADER, having an opening tag 200a and a closing tag 200b. The root element 200a-200b represents the first element type. In this example, there is only one instance of the first element type. Fora standard XML data structure, there will be only one root element. Elements 210 are those child elements of the root element 200a-200b having only data content, including element names ORDERID, CUSTOMERID, ORDERDATE, SHIPDATE, COMMPLANID, SALESREPID, TOTAL and STATUSID. These child elements are included within the grouped hierarchy of the first element type. Note that if each child element of any parent element contains element content, that parent element will still represent a distinct element type, even though it has no child element containing only data content. This facilitates duplicating the original data structure of the XML source data file upon decompression. In this situation, the data content of the compressed file for that element type would be a null set, and the listing of element names as described below would simply contain the parent element name.

Elements 220 represent a second element type, in this case ORDER_ATTACHMENT. In this example, there are six instances of the second element type, i.e., elements 220₁-220₆. Each instance of the second element type includes child elements 221 having only data content, including element names ATTID, ATTTYPE, ORDERID and ATTACHMENT.

Element 230 represents a third element type, in this case ORDER_TAX. In this example, there is only one instance of the third element type. This element type includes child elements 231 having only data content, including element names ORDERTAXID, ORDERID, TAXTYPE, COUNTRY and AMOUNT.

Elements 240 represent a fourth element type, in this case ORDER_LINE. In this example, there are three instances of the fourth element type, i.e., elements 240₁-240₃. Each instance of the fourth element type include child elements 241 having only data content, including element names ORDERLINEID, ORDERID, PRODUCTID, QUANTITY, PRICE, DISCOUNT and NOTE. Each instance of the fourth element type further includes child elements 250. Elements 250 represent a fifth element type, in this case ORDER_LINE _DIST. In this example, there are two instances of the fifth element type included in the first instance of the fourth element type, and three instances of the fifth element type included in each of the second and third instances of the fourth element type. Each instance of the fifth element type 250 includes child elements 251 having only data content, including the element names ORDERLINEDISTID, ORDERLINEID, QUANTITY, STOREID and NOTE.

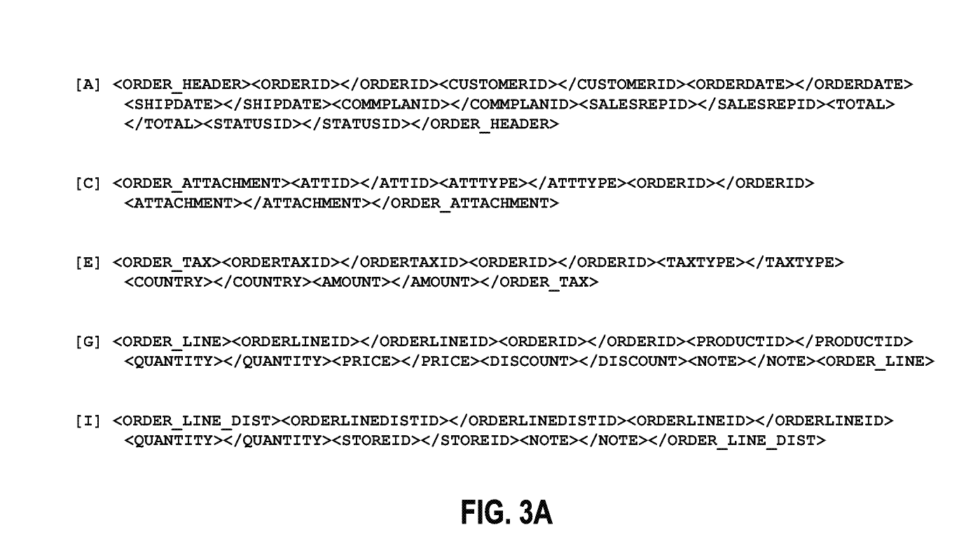

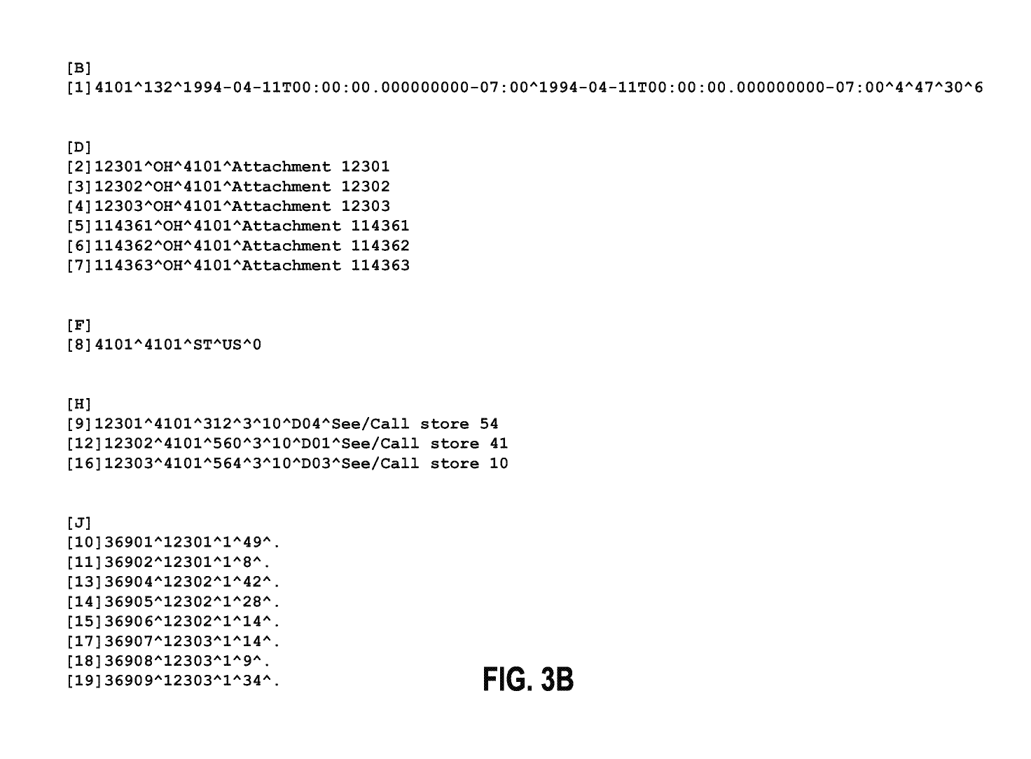

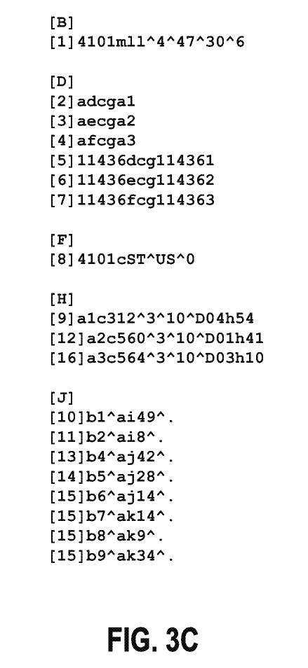

FIGS. 3A-3C collectively represent examples of compressed data structures generated in response to the XML source data of FIGS. 2A-2C in accordance with embodiments of the disclosure, depicting the transformation of the source data structure in this example. The first tier of compression is to reorganize the XML source data based on its identified hierarchy. In this example, five groups of data hierarchies sharing the same structure were identified, i.e., those element types corresponding to elements 200, 220, 230, 240 and 250. Each element type includes a parent element and any child element of that parent element containing only data content. If any child element of that parent element contains element content, that child element becomes the parent element for an additional element type. This process is repeated until no additional parent elements are identified. Each instance of an element type contains the same child elements, i.e., they share the same structure. If an element name were to be associated with different sets of child elements within the same source data, each different set would be represented by a different element type.

FIG. 3A depicts the separation of the element names, including opening and closing tags, for each child element associated with a particular element type and containing only data content. The notation [A], [C], [E], [G] and [I] denotes a memory pointer to the respective list of element names and then location of each element type's respective instances of data content. These representations, e.g., [A], are arbitrary and used for convenience to represent actual pointers to specific locations as would be contained in the actual data file.

FIG. 3B depicts the separation of the data content associated with each element type. The notation [B], [0], [F], [H] and [J] denotes the beginning of the respective groupings of data content for each element type [A], [C], [E], [G] and [I], in this example. Again, these representations are arbitrary and used for convenience. The integer values inside brackets, i.e., [1], [2], [3], etc., denote counters representative of the relative location of the instance of the element type within the source data structure. For example, the first and second instances of the fifth data type, i.e., J10 and J11, occur between the first and second instances of the fourth data type, i.e., H9 and H12. Thus, as a new instance of any element type is encountered when reading the source data sequentially, the counter is incremented until an end of file is encountered. This counter serves as an indicator of a relative order of the various instances of element types. In this manner, the compressed XML data can be decompressed to duplicate the relative order between hierarchies contained in the original XML source data.

Data content for each instance of a particular element type includes a data value corresponding to each child element of that element type, if any, in an order corresponding to the order of the child element names for that element type. As shown in FIG. 3B, each data value is separated from other data values of that instance of the element type by some delimiter, represented as a “̂” character in FIG. 3B.

Accordingly, the first tier of compression includes a representation of element names associated with each element type, those element names including a parent element and any child elements containing only data content. The element names of the child elements for a particular element type may be listed in the order they are encountered in the source data to facilitate duplicating the original data structure upon decompression. A representation of element names associated with an element type further includes an indicator of a location within the compressed data file of the data content associated with that element type. The first tier of compression further includes a representation of data content associated with each instance of each element type. An order of the data content for an instance of an element type is representative of an order of the element names of the child elements for that element type that include only data content. A representation of data content associated with an instance of an element type includes an indicator of a relative order within the instances of all element types identified for the source data. It is this separation of representations of element names for each element type and representations of data content for each instance of each element type that constitutes the reorganization of the first-tier compression. Note that while the examples of FIGS. 3A-3B are in plain text, other representations are permitted, such as binary, hexadecimal, etc.

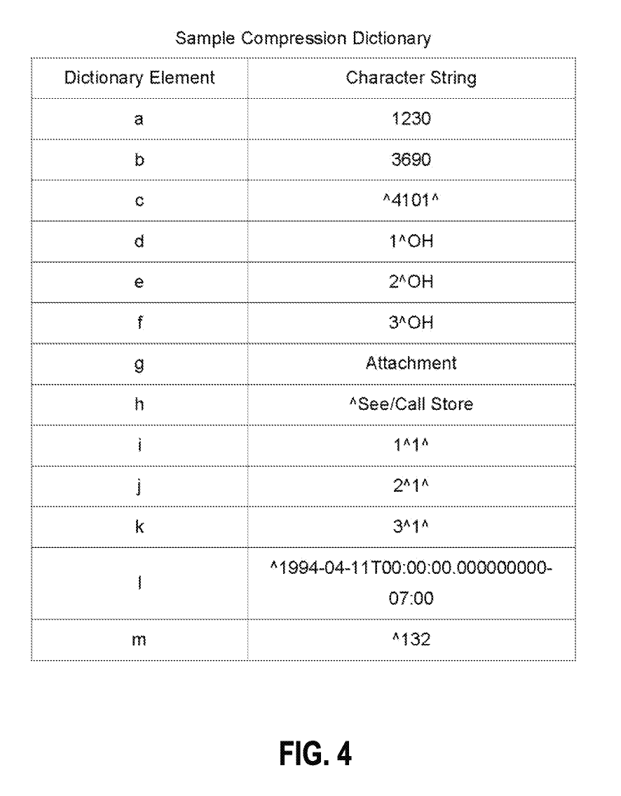

For the sample XML source data of FIGS. 2A-2C, the first tier of compression represented by FIGS. 3A-3B shows compressed data of approximately one-fourth the size of the source data. Note that because the first tier of compression retains the plain text of the source data during the reorganization, further space savings can be realized by applying some other compression technique to the reorganized data. For example, L-Z compression can be applied to the reorganized data. L-Z compression builds a dictionary of recurring character strings. Each recurring character string of the dictionary is represented by some dictionary element. The compression technique then replaces the identified recurring character strings within the data file with the dictionary element. When the file is decompressed, the same dictionary is then used to replace the dictionary elements in the compressed data file with the character string corresponding to that dictionary element. Continuing with the example reorganized as shown in FIGS. 3A-3B, a compression technique, e.g., L-Z compression, might build a dictionary containing the dictionary elements and character strings depicted in FIG. 4. Note that for convenience, the dictionary elements are represented as simple characters. However, the dictionary elements would assume the convention of whatever compression technique is chosen. The various embodiments are not limited by any particular compression technique applied to the reorganized data of the foregoing embodiments. However, rather than building a dictionary in line, as is normally done in L-Z type data compression, the compression dictionaries used with embodiments of the disclosure are either maintained externally to the compressed data file or contained contiguously in a special-purpose block inside the compressed data file.

Using the sample dictionary of FIG. 4, the reorganized data of FIG. 3B could be represented as depicted in FIG. 3C by replacing the character strings of the dictionary with their corresponding dictionary elements, further reducing the size of the compressed data. It is noted that although the foregoing example only applied this second tier of compression to the data content portion of the reorganized data, such techniques could be applied to the reorganized data as a whole, i.e., including a second-tier compression of the listings of element names. Also note that these actions are depicted as separate steps in the examples, to more clearly describe the different aspects of the compression, but that they can be applied in a single pass. Accordingly, the second-tier compression can either be performed after generating the representations of data content of the first-tier compression, or concurrently with generating the representations of data content of the first-tier compression.

If the dictionary for a second-tier compression technique is kept externally, the dictionary can be used for several compressed files, thus decreasing overhead. This also allows the external dictionary to be larger and thus provide better compression ratios. Furthermore, since the dictionary is not in-line with the compressed data, the data can be decompressed at any point in the file, rather than requiring sequential access. However, if the dictionary is separated from the compressed data file, neither is whole without the other. If the compression dictionary becomes lost, then compressed files that use it cannot be decompressed. This risk can be mitigated by placing the dictionary in a special-purpose block within the compressed data file, such as at the end of the compressed data file or other designated location, with a reserved location at the beginning of the compressed data file to point to its location. This approach preserves the self-integrity of each compressed XML file while still maintaining the ability for random access to the compressed data blocks.

Using the notation as described herein, the hierarchy of the data structure of the XML source data of FIGS. 2A-2C can be represented as:
[A[B][C[D]E[F]G[H[I[J]]]]]

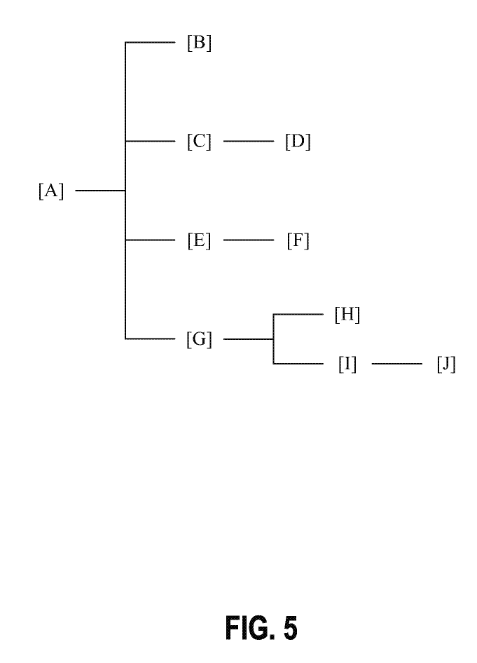

Alternatively, FIG. 5 depicts a representation of the hierarchy of the data structure of the XML source data of FIGS. 2A-2C as a tree index in accordance with an embodiment of the disclosure. Both the nested representation of hierarchy presented in the previous paragraph, and the graphical representation of hierarchy presented in FIG. 5 represent the relationship between the various groupings of data hierarchies sharing the same structure.

Full decompression of the data file would occur in reverse. A simple, but slower, method would be to decompress the file in two passes, i.e., the compressed data file would first be decompressed according to the second-tier compression technique, if used, to restore the reorganized data structure of the first-tier compression, then this reorganized data would be decompressed according to the first-tier compression technique to restore the source data structure. A faster method would involve using the hierarchal pointers to randomly access the compressed file to apply decompression in a single pass. It is noted that whether a single-tier compression or a dual-tier compression is performed, the various embodiments permit random access to specific data because a parser can seek to any point in the file and begin decompression and parsing without having to decompress the entire file up to at least the point containing the target data. In other words, because the reorganized data structure includes indicators pointing to locations of data for specific instances for each element type, and because the compression dictionary is not stored in-line with the compressed data, the parser can decompress the beginning of the file until the desired element type is located, and then jump to the location of the data for that element type without decompressing all interposing file content.

Alternatively, jump lists can be created to avoid decompressing the data file until the location indicators are identified for the target data. A jump list may contain values indicative of a location of a representation of element names for at least one element type and of a length of the representation of element names for the at least one element type. The jump list may further contain values indicative of a location of the representation of data content corresponding to at least one instance of the at least one element type and of a length of the representation of data content for the at least one instance of the at least one element type. The jump list can be created at the same time the XML source data is created, or when the XML source data is compressed, or after the XML source data is compressed. Note that decompression of the compressed data file will be necessary if the jump list is created before compression is complete. For example, if the jump list is created prior to the first-tier compression, then the compressed data file will need to be fully decompressed for the locations of the jump list to correspond to the data file. If the jump list is created after a first-tier compression, but prior to a second-tier compression, the compressed data file would need to be decompressed back to the first-tier compression level. However, if the jump list is created after compression is completed, either a single-tier compression or a dual-tier compression, only the relevant portions of the compressed data file need be decompressed in order to access the data content identified by the jump list.

The jump list could be implemented as an external file or could be included in the compressed data file. Jump lists may be created to fulfill specific access requirements. For example, if someone desired to have sequential access to a subordinate structure in the compressed data, a jump list can be created for each starting point of that structure. A program can then rapidly seek to each desired location, and decompress only the data desired to satisfy the query. B-tree style indexing can also use jump lists to effectively create detailed indexes on components of the compressed XML data.

Using the sample compressed XML source data of FIGS. 3A-3B for example, a jump list may be created for quick access to all records of the <ORDER_LINE> element type, which could be represented as follows:
[byte location of ORDER_LINE element names],[length of element names]
[byte location of ORDER_LINE row H9], [length of row H9]
[byte location of ORDER_LINE row H12], [length of row H12]
[byte location of ORDER_LINE row H16], [length of row H16]

An index jump list would be similar, but would associate jump locations with indexed values, rather than a sequential list. A jump list can be customized to a particular access method. For example, if someone wanted to read all of the <ORDER_LINE> data sequentially, the jump list could contain just the initial byte location and the length of the entire block instead of just one row.

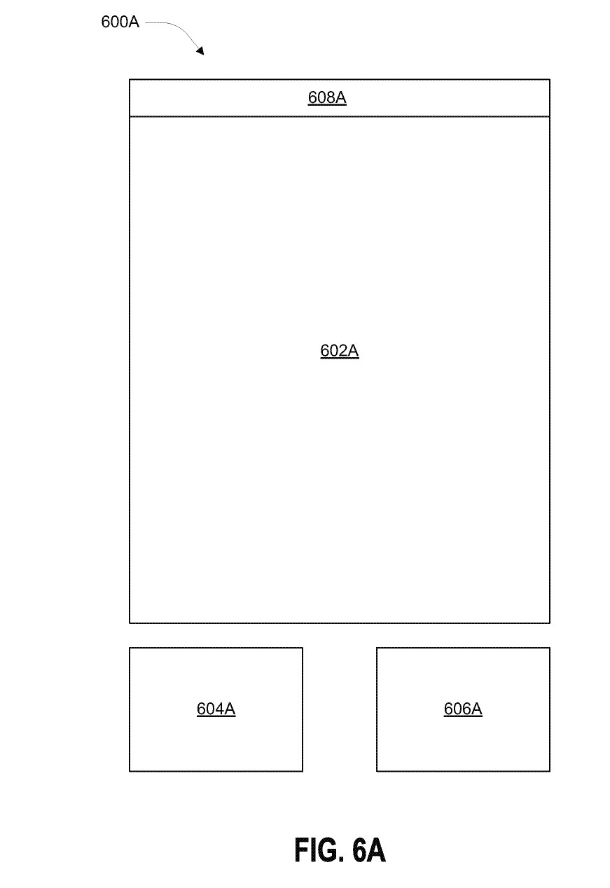

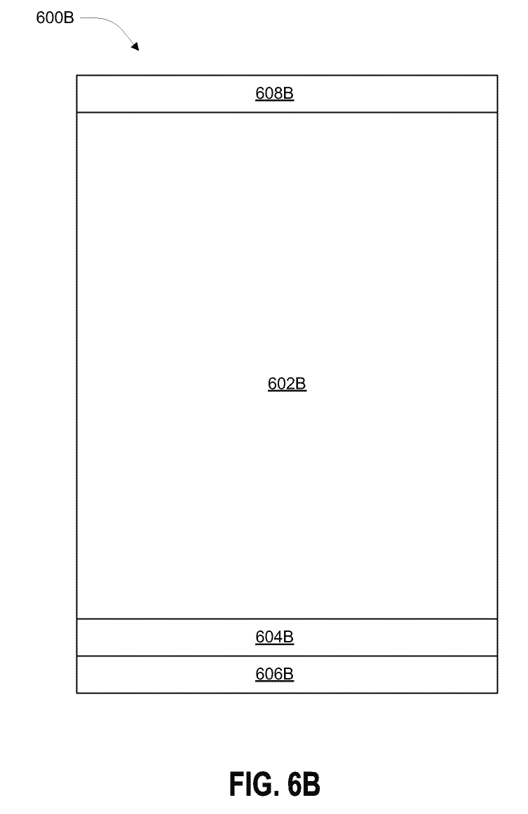

FIGS. 6A-6B represent compressed file structures in accordance with embodiments of the disclosure. FIG. 6A represents a compressed data file 600A in accordance with an embodiment of the disclosure where the compressed data 602A is separated from an optional compression dictionary 604A and an optional jump list 606A. The compressed data 602A may, for example, represent a single-tier compression or a dual-tier compression in accordance with an embodiment of the disclosure. If the decompression protocol does not control what compression dictionary is used to decompress the compressed data file 600A, the compressed data file 600A may include a portion 608A to designate a particular compression dictionary 604A to use for decompressing a second-tier compression, if necessary. The compressed data file 600A is typically stored on a computer-usable storage medium to permit creation, access and/or manipulation of the compressed data file 600A by a computing device.

FIG. 6B represents a compressed data file 600B in accordance with an embodiment of the disclosure where an optional compression dictionary 604B and an optional jump list 606B are stored in the same data file as the compressed data 602B. The compressed data 602B may, for example, represent a single-tier compression or a dual-tier compression in accordance with an embodiment of the disclosure. The compressed data file 600B includes a portion 608B to identify a location of an integral compression dictionary 604B to use for decompressing a second-tier compression, if necessary, and to identify a location of an integral jump list 606B if one is included in the compressed data file 600B. The compressed data file 600B is typically stored on a computer-usable storage medium to permit creation, access and/or manipulation of the compressed data file 600B by a computing device. It is noted that additional examples of compressed file structures may be generated in accordance with embodiments of the disclosure. For example, a compressed file structure may include a compression dictionary integral with the compressed data such as shown in FIG. 6B, and a jump list separated from the compressed data such as shown in FIG. 6A. Alternatively, a compressed file structure may include a jump list integral with the compressed data such as shown in FIG. 6B, and a compression dictionary separated from the compressed data such as shown in FIG. 6A. In addition, the jump list may be eliminated from various embodiments, and the compression dictionary may be eliminated when no second-tier compression is performed, or a second-tier compression is performed using a compression technique that does not rely on a compression dictionary.

Although specific embodiments have been illustrated and described herein it is manifestly intended that the scope of the claimed subject matter be limited only by the following claims and equivalents thereof.

1. A method of compressing XML source data, comprising:
identifying each element type of the XML source data, each element type including one parent element and each element type having one or more instances in the XML source data;
generating a representation of element names for each identified element type, wherein each representation of element names comprises the element name of the parent element of that element type and element names of any child elements of that parent element that contain only data content;
generating a representation of data content for each instance of each element type separate from the representation of element names of the element types; and
storing the representations of element names and the representations of data content on a computer-usable storage medium.

2. The method of claim 1, further comprising generating a jump list containing values indicative of a location of a representation of element names for at least one element type and of a length of the representation of element names, the jump list further containing values indicative of a location of the representation of data content corresponding to at least one instance of the at least one element type of a length of the representation of data content for the at least one instance of the at least one element type.

3. The method of claim 2, further comprising storing the jump list on the computer-usable storage medium in a same data file with the representations of element names and the representations of data content, and storing an indicator in the same data file of the location within the same data file of the jump list.

4. The method of claim 2, further comprising storing the jump list on a computer-usable storage medium in a different data file than the representations of element names and the representations of data content.

5. The method of claim 4, further comprising storing an indicator in the data file containing the representations of element names and representations of data content of a location of the jump list.

6. The method of claim 2, wherein generating a jump list comprises generating the jump list at a time selected from the group consisting of prior to generating the representations of element names and the representations of data content; after generating the representation of element names and the representations of data content, and prior to performing a second-tier compression; and after compression of the XML source data is complete.

7. The method of claim 1, wherein, if a parent element of a particular element name is associated with a first set of child elements containing only data content for one or more instances, and a parent element of the particular element name is associated with a second set of child elements containing only data content for one or more other instances, identifying each element type of the XML source data comprises identifying a first element type corresponding to each parent element of the particular element name associated with the first set of child elements and identifying a second element type corresponding to each parent element of the particular element name associated with the second set of child elements.

8. The method of claim 1, further comprising grouping the representations of data content with other representations of data content for a same element type such that the groupings of representations of data content represent data content for a same set of child elements.

9. The method of claim 1, wherein generating a representation of data content for each instance of each element type further comprises associating a counter with the representation of data content for each instance of each element type indicative of an order of occurrence for each instance of each element type within the XML source data.

10. The method of claim 1, further comprising applying a second-tier compression to at least one of the representations of element names and the representations of data content, wherein the second-tier compression is performed at a time selected from the group consisting of after generating the representations of data content and concurrently with generating the representations of data content.

11. The method of claim 10, further comprising generating a compression dictionary for the second-tier compression.

12. The method of claim 11, further comprising storing the compression dictionary on the computer-usable storage medium in a same data file with the representations of element names and the representations of data content, and storing an indicator in the same data file of a location within the same data file of the compression dictionary.

13. The method of claim 11, further comprising storing the compression dictionary on a computer-usable storage medium in a different data file than the representations of element names and the representations of data content.

14. The method of claim 1, wherein generating a representation of element names for each identified element type further comprises associating a pointer with each representation of element names indicating a location of the representations of data content for its respective element type.

15. A non-transitory computer-readable storage medium containing instructions that, when executed, cause a processor to:
identify each element type contained in an XML source document, each element type including one parent element and each element type having one or more instances in the XML source document;
generate a representation of element names for each identified element type, wherein each representation of element names comprises the element name of the parent element of that element type and element names of any child elements of that parent element that contain only data content;
generate a representation of data content for each instance of each element type separate from the representation of element names of the element types; and
store the representations of element names and the representations of data content on a computer-readable storage medium.
